(19) United States
(12) Patent Application Publication
(10) Pub. No.: US 2017/0323405 A1
(43) Pub. Date: Nov. 9, 2017

(54) Process and method for aircraft occupant destination ground transportation and or lodging determination

(71) Applicant: Clayton M Jackson, Statesboro, GA (US)

(72) Inventor: Clayton M Jackson, Statesboro, GA (US)

(21) Appl. No.: 15/587,592

(22) Filed: May 5, 2017

Related U.S. Application Data
(60) Provisional application No. 62/333,172, filed on May 7, 2016.

(51) Int. Cl. G06Q 50/14; G06Q 50/12; G06Q 10/02

(52) U.S. Cl. CPC G06Q 50/14; G06Q 10/025; G06Q 50/12

(57) ABSTRACT

The present invention generally relates to a system and method for receiving and processing flight plan data and associated content, either manually or automatically, and combining said data with individual selections necessary to automatically determine the mode of ground transportation, and/or lodging, aircraft occupants will need upon arriving at their destination airport. More particularly, the present invention pertains to a data collection utility accessible over the Internet.

### BACKGROUND

There are currently methods for determining the amount of aviation traffic arriving at a given airport at any given time, but there is currently no automated means for determining which mode of ground transportation or lodging the occupants of these aircraft will need upon arriving at their destination airport. As a result, the occupants (i.e., Pilot, Flight Crew, Passengers, etc.) must rely upon traditional methods to fulfill these possible requirements.

This procedure includes determining what ground transportation services or lodging providers are available at their destination airport. To do this, a pilot/person must determine if a Fixed Based Operator (FBO) services the airport. There can be a number of different FBO's at an airport. Some airports are unattended and do not have a FBO. Upon determining this information, the pilot must either contact the FBO to see what differing types of transportation they provide or find a ground transportation provider in the general location surrounding and near their destination airport. The later process can be both arduous and time consuming without even considering the time required in determining lodging most suitable for providing ready access to airport activities.

The preferred method of contacting a destination FBO has traditionally been to telephone them prior to departing the airport of origin or, possibly, to contact them via radio communications prior to arriving at the airport. Both methods are problematic. Telephoning an FBO requires time, and if the FBO does not provide the services you need, one must then begin the search to procure local transportation and/or lodging. Conversely, radio communication with an FBO prior to arriving at an airport requires first, that the pilot remembers to do such, second, that the pilot gives the FBO enough lead time to procure said services in a timely manner, and last, the pilot must monitor two radio frequencies as to not miss an important radio call from Air Traffic Control (ATC) or miss an important call out or procedure because of this unnecessary distraction during a critical phase of flight.

This process can be cumbersome and time consuming because it includes determining (and consequentially procuring and scheduling) which mode of transportation and/or lodging would be most desirable for themselves and/or their passengers, which Fixed Based Operator (FBO) they will be using at their destination, which transportation services the FBO provides, taxi service availability, hotel shuttlebus schedules, etc. Presently, there are no systems, methods or solutions for determining and processing this information automatically.

### Solution

The present invention seeks to provide a solution to these problems by providing a computer program with a user interface which may be initiated either manually or automatically. Manual initiation requires the user to activate the application via an “App”, an application, a website address or a link thereto, or any other number of unforeseen methods to the same end. Automatic program activation requires the completion of a flight plan filed with the United States Federal Aviation Administration (FAA) (or, outside of the United States, the comparably associated governing agency). Said computer program queries a database and presents options to the user listing all of the available services at the user's destination. These services may or may not include, but are not limited to, Fixed Based Operator (FBO), Aircraft Maintenance Shops, Hanger Locations, Taxicabs, Shuttle Buses, Buses, Trains, Rental Cars, Boats, Ferries, Water Taxis, Air Taxis, Courtesy Cars, Own Transportation, Hotels, Motels, Suites, Bed & Breakfasts, etc. The user's service selection populates a database. The computer application queries the database and provides real-time results as to which form of transportation and/or lodging the aircraft occupants will be using and at what time and location they will be requiring said services.

### Basic Description of how it Works

Data pertaining to the flight are received, parsed and populated in a database. This flight information can be entered either manually or automatically. Automatic population of flight plan data can be received either from use of an independent flight planning application or through the Aircraft Situation Display to Industry (ASDI). Manual entry is accomplished through use of a computer application user interface (Window) presenting itself to the pilot. Regardless of which method is used to populate flight plan information to the database, a new Window presents itself to the user querying which Fixed Based Operator (FBO) or maintenance facility they will be disembarking from after having arrived at their destination airport. Upon making this selection, the database is queried, pertinent data is then received, and a new Window is presented the user querying the particular form of ground transportation desired (i.e., Taxicab, Rental Car, Shuttle Bus, Courtesy Car, Own Transportation, etc.). Upon selecting the desired ground transportation, the previously parsed data pertaining to the FBO (i.e., address, phone number, email, etc.) are combined with the data pertaining to the selected ground transportation and the filed flight plan data and are forwarded to a local service provider. Should the user require lodging, instead or in conjunction with transportation, another Window presents itself querying the particular form of lodging desired. Upon selecting the desired lodging preference, the previously parsed data pertaining to the FBO (i.e., address, phone number, email, etc.) are combined with the data pertaining to the selected ground transportation (if inclusive) and the filed flight plan data and are forwarded to a local service provider.

### BRIEF DESCRIPTION OF THE DRAWINGS

FIG. 1 is a diagrammatic view of a computer system of one implementation.

FIG. 2 is a process flow diagram illustrating the process for aircraft occupant destination ground transportation and/or lodging determination in one embodiment of the present system and method illustrated in FIG. 1.

FIG. 3 is a diagrammatic view of a representative web page according to one embodiment of the present invention.

FIG. 4 is a diagrammatic view of a representative web page according to one embodiment of the present invention.

FIG. 5 is a diagrammatic view of a representative web page according to one embodiment of the present invention.

FIG. 6 is a diagrammatic view of a representative web page according to one embodiment of the present invention.

### DETAILED DESCRIPTION OF THE INVENTION

For the purposes of promoting and understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

On any given day there are likely to be more than 60,000 flight plans filed in the United States. Each of these flights are from origination to destination. The term “destination” herein means the location where the flight lands and stops flying, at least for a while. There can be both intermediate destinations, such as landing for refueling before continuing to a further destination, and final destinations, such as landing to complete the purpose of the flight.

On any one of these aircraft is a minimum of one occupant. As very few airports have transient lodging located on the field it is reasonable to assume the airport is not the final destination for these occupants. To continue this journey the occupants will more likely than not require some form of ground transportation (i.e., Taxicab, Shuttle bus, Rental car, etc.). Currently there are no systems in place to determine which form of ground transportation these occupants will be requiring.

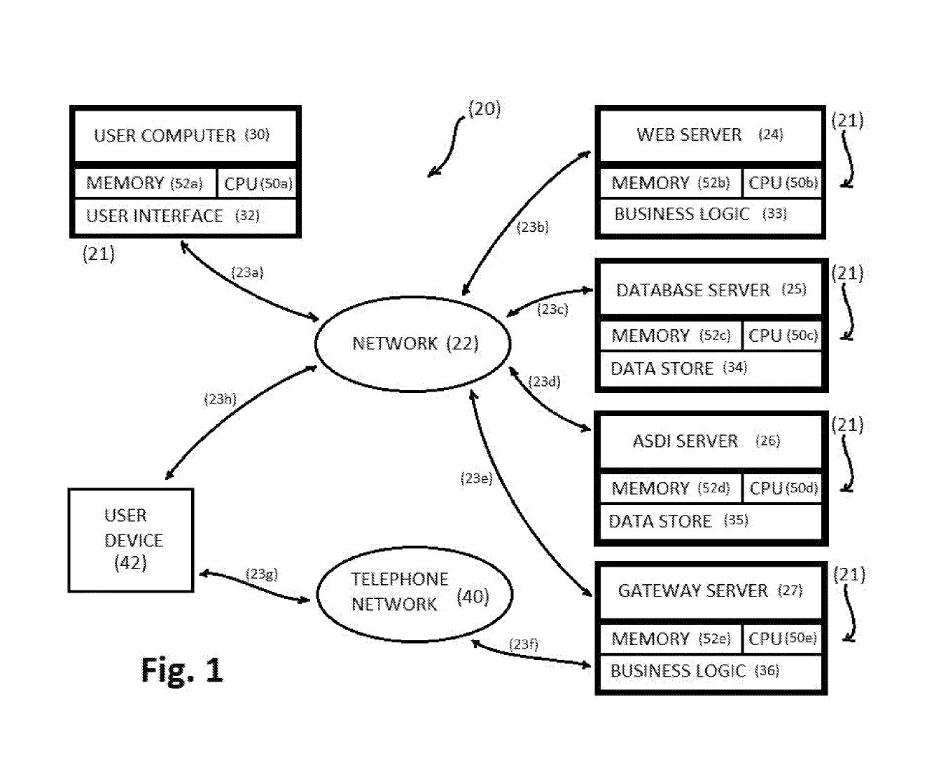

Turning to FIG. 1, a diagrammatic view of computer system 20 suitable for use in one embodiment of the present invention is shown. Computer system 20 includes computer network 22, and functions to provide the novel service described herein. Computer network 22 couples together a number of computers 21 over network pathways 23a-23e. Telephone network 40 couples together Gateway Server 27 and user device 42 over pathways 23f and 23g. Preferably, telephone network 40 comprises both the public switched telephone network (PSTN) and one or more cellular networks. In one form, computers 21 may also be connected to user device 42 through network 22 via network pathway 23h, such as when user device 42 is a VoIP endpoint, wireless device, smart phone, or other digital communication device. Any of pathways, 23 may alternatively be traditional PSTN connections, digital lines (such as T1, T3, OC3), or any other transmission medium suitable for carrying content, such as a wireless or cellular network.

More specifically, system 20 includes several servers, namely Web Server 24, Database Server 25, ASDI Server 26, and Gateway Server 27. System 20 also includes at least one user computer 30. While computers 21 are each illustrated as being a server or client, it should be understood that any of computers 21 may be arranged to include both a client and server. Furthermore, it should be understood that while five computers 21 are illustrated, more or fewer may be utilized in alternative embodiments. In particular, it shall be appreciated that a large number of client computers, similar to user computer 30, may be in use within system 20 for performing operations such as allowing numerous individual remote users or entities to connect to Web Server 24.

Turning to implementation specifics, in the illustrative embodiment, computers 21 include one or more processors or CPUs (50a, 50b, 50c, 50d, and 50e respectively) and one or more types of memory (52a, 52b, 52c, 52d, and 52e respectively). Each memory 52a-e preferably includes a removable memory device. Each processor 50a-50e may be comprised of one or more components configured as a single unit. Alternatively, when of a multi-component form, a processor 50a-50e may have one or more components located remotely relative to the others. One or more components of each processor 50a-50e may be of the electronic variety defining digital circuitry, analog circuitry, or both. In one embodiment, each processor 50a-50e is of a conventional, integrated circuit microprocessor arrangement.

Each memory 52a-52e (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown, in one embodiment each computer 21 is coupled to a display and/or includes an integrated display. Computers 21 may be of the same type, or a heterogeneous combination of different computing devices. Likewise, displays may be of the same type, or a heterogeneous combination of different visual devices. Although not shown, each computer 21 may also include one or more operator input devices such as a keyboard or mouse to name just a few representative examples. Also, besides a display, one or more other output devices may be included such as a printer. As such, various display, input and output device arrangements are possible.

Computer network 22 can be in the form of a wireless or wired Local Area Network (LAN), Municipal Area Network (MAN), Wide Area Network (WAN), such as the Internet, a combination of these, or such other network arrangement as would occur to those skilled in the art. In a further form, several computers 21, such as Web server 24, Database Server 25, and Gateway Server 27 may be coupled together by a secure portion of network 22 while remaining connected to ASDI Server 26 and user computer 30 via an unsecured portion of network 22. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations. Web Server 24 is configured as a web server that hosts application business logic 33 used for querying and updating Database Server 25 with user inputted selections. Database Server 25 is configured as a database server for, but not limited to, storing user inputted information and aviation information provided by ASDI Server 26 and the remote users, and user computer 30 is configured for providing a user interface 32 for accessing the FBO identification, FBO fuel prices, available taxicab services, available rental car services, courtesy car availability, shuttle bus availability, own transportation or no service requested. User interface 32 of user computer 30 can be an installable application such as one that communicates with Web Server 24, can be browser-based, and/or can be embedded software, to name a few non-limiting examples.

In one embodiment, software installed locally on user computer 30 or user device 42 is used to communicate with Web Server 24. In another embodiment, Web Server 24 provides HTML pages, data from web services, and/or other Internet standard or company proprietary data formats to user computer 30 or user device 42 when requested. It shall be appreciated that in alternate forms user computer 30 and user device 42 may be any web-enabled device, such as an iPod, iPad, Tablet, or cellular phone, to name just a few illustrative examples. One of ordinary skill in the art will recognize that the term web server is used generically for purposes of illustration and is not meant to imply that network 22 is required to be the Internet. As described previously, network 22 can be one of various types of networks as would occur to one of ordinary skill in the art. Data store 34 on Database Server 25 can store data such as FBO identification, FBO physical address, FBO email address, FBO phone number, FBO fuel prices, available taxicab services, available rental car services, courtesy car availability, shuttle bus availability, own transportation, no requested services (as a user selectable option) and/or user content segments to name a few representative examples.

Gateway Server 27 includes business logic 36 and associated hardware allowing operation as an outgoing communication server, such as an auto dialer and/or other suitable hardware, for distributing information to a user, as triggered by the novel service. In one form, Gateway Server 27 may initiate a digital communication session with user device 42 via network 22. In an alternate form Gateway Server 27 may transmit information in the form of a message, such as an email or SMS (text message), to user device 42 via network 22. Depending upon the type of information being inputted by the remote user, user device 42 may be a smart phone, iPod, iPad, Tablet, etc. such as one implementing GSM or CDMA technology, a digital telephone, such as a VOIP phone, or another computer, such as a server. It shall be appreciated that more than one user device will be included in use of system 20, but that only one has been shown generically to preserve clarity. Further, it shall be appreciated that the types of user devices connected to system 20 need not be of the same type, but that digital, analog, and other technologies may be accommodated simultaneously.

In the illustrative embodiment, flight plan information is received from ASDI Server 26 which is at least one server that is a part of the Aircraft Situation Display to Industry service (ASDI) provided by the Federal Aviation Administration (FAA). The feed provided by the ASDI service may be in real time or delayed, such as subject to a five minute delay. Connections to the feed are established in a structured format according to Aircraft Situation Display to Industry: Functional Description and Interface Control Document (available at www.fly.faa.gov/ASDI/asdi.html).

Typical applications of system 20 would include more client computers, such as client computer 30, at various locations, although only one client computer 30 has been illustrated in FIG. 1 to preserve clarity. Furthermore, although four servers 24, 25, 26, 27 are shown, it will be appreciated by those of ordinary skill in the art that one or more features provided by Web Server 24, Database Server 25, and Gateway Server 27 could be provided by the same computer or varying other arrangements of computers at one or more physical locations and still be within the spirit of the invention. Farms of dedicated servers, a single proprietary system, and/or a Storage Area Network (SAN) could also be provided to support the specific features if desired. In the illustrative embodiment, in order to flexibly handle the large quantity of data received by the novel service, Database Server 25 includes a relational database, such as SQL, as is known to one of skill in the art.

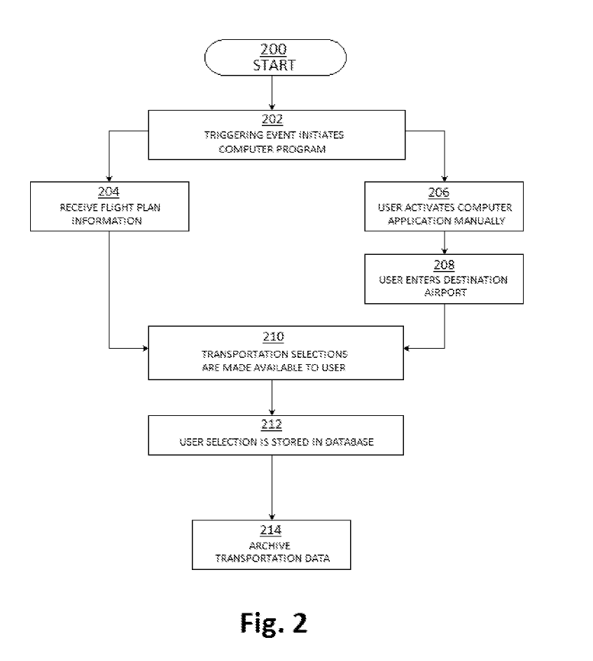

Turning to FIG. 2, with continued reference to FIG. 1, a flowchart illustrating a method for determining and processing requested ground transportation or lodging is illustrated. The process begins at start point 200 with the novel service being activated through a triggering event 202. This triggering event can be caused either by manually selecting the application, website or computer program 206, or the process begins upon receiving a flight information message 204 from ASDI server 26, or an independent flight planning computer program via Web Server 24. In one form, the flight information messages are received and processed by Database Server 25. In other forms, various other servers may process the data prior to entry into the data store 34. The flight plan information messages may be of a variety of different types, with each type providing various fields of information.

Once activated, data can be entered either manually, by the user, or imported from Data Store 34. Manually entered data can be inputted using an instrument for collecting data presented on User Computer 30 or User Device 42. Said data primarily consists of Aircraft Registration and Destination Airport information 208. Inputted data is subsequently stored in Data Store 34. Destination Airport data is used by Business Logic 33 to retrieve transportation service provider or lodging data from Database Server 25. Parsed transportation service provider or lodging data is presented on User Computer 30 or User Device 42. Upon selection of transportation service provider or lodging by user 210, transportation service provider or lodging selection 212 is archived 214 in Data Store 34.

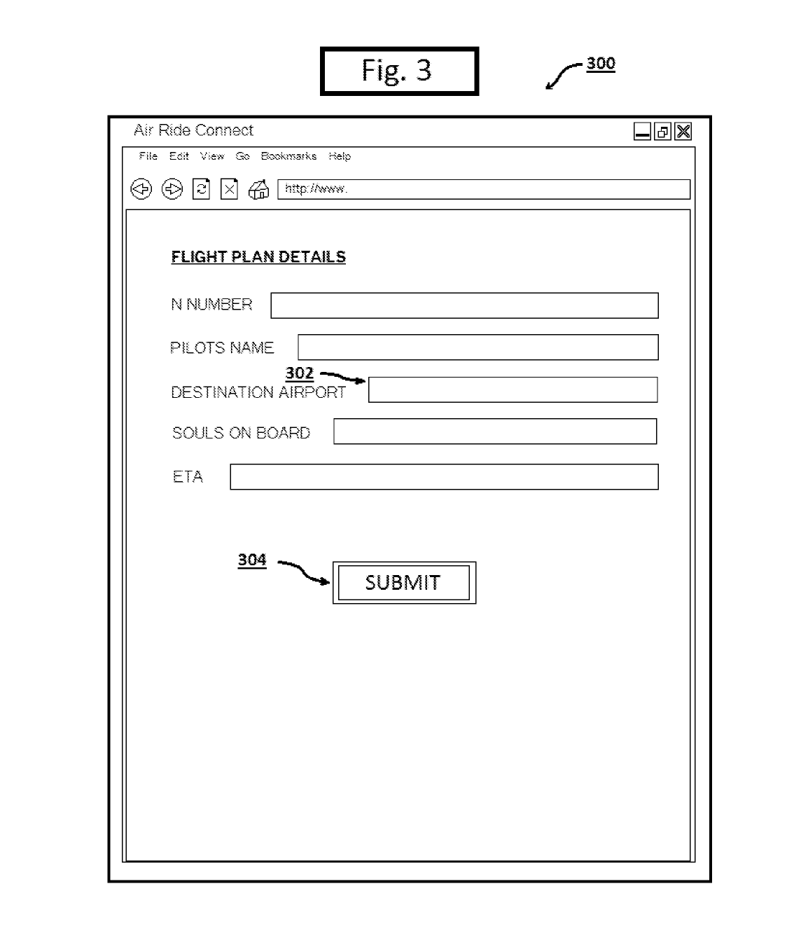

For purposes of illustration, and with continued reference to FIG. 1, FIG. 3 shows a sample web page 300 presented to a remote user on client computer 30 by Web Server 24. Web Page 300 includes a plurality of fields suitable for allowing the remote user to submit flight plan details. For purposes of determining what forms of ground transportation or lodging will be available to the user at their destination airport, web page 300 includes Destination Airport field 302. The user completes the form and transmits the information to Web Server 24 by selecting Submit button 304. It shall be appreciated that other notification triggers, notification delivery methods, and the like may be provided for in alternative embodiments. Other fields which may be illustrated on web page 300 are merely a convenience to the user and are of no consequence to the function of the novel service.

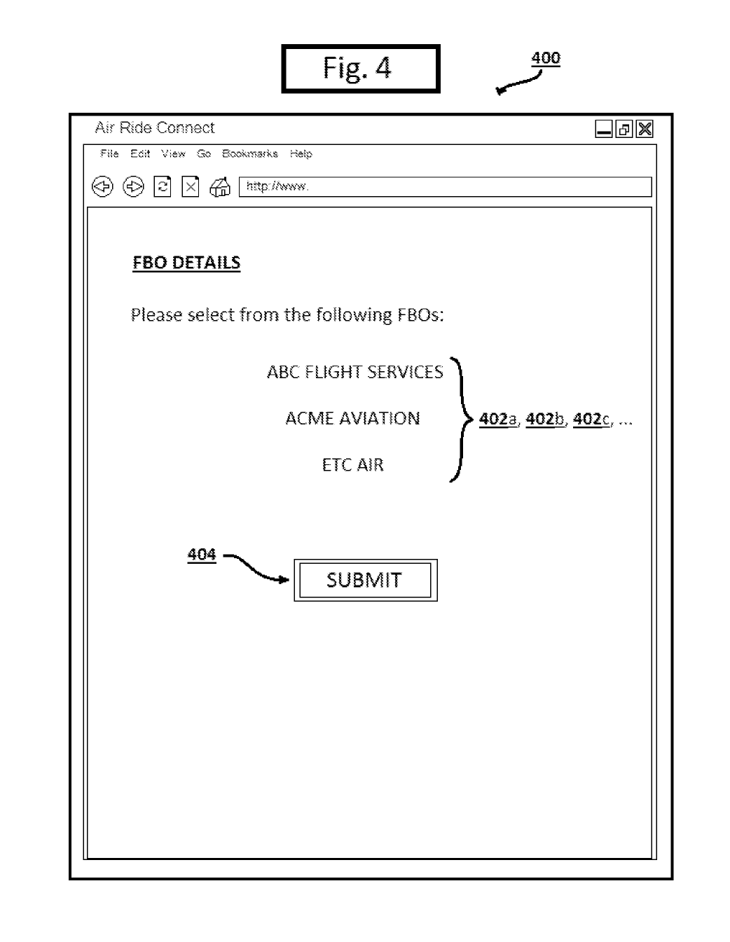

For purposes of illustration, and with continued reference to FIG. 1, FIG. 4 shows a sample web page 400 presented to a remote user on client computer 30 by Web Server 24. Web Page 400 includes a plurality of fields suitable for allowing the remote user to select from differing FBOs 402a-402c which may be serving the airport based on either automatically populated flight plan data from ASDI Server 26, an independent flight planning computer program via Web Server 24, or manually inputted information from Destination Airport field 302. The user completes the form and transmits the information to Web Server 24 by selecting Submit button 404. It shall be appreciated that other notification triggers, notification delivery methods, and the like may be provided for in alternative embodiments.

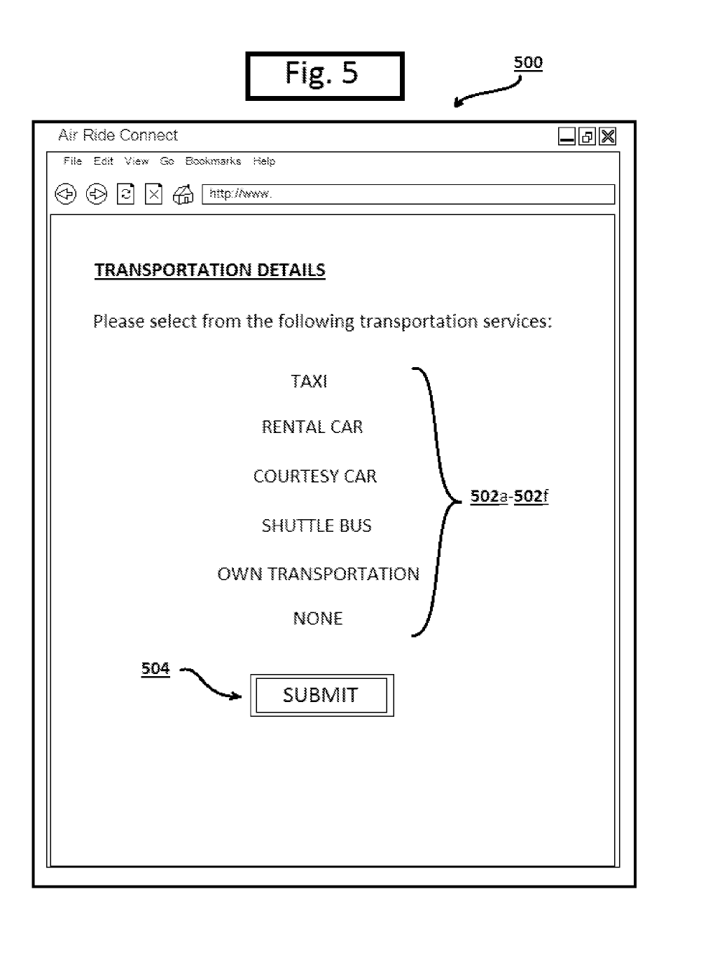

For purposes of illustration, and with continued reference to FIG. 1, FIG. 5 shows a sample web page 500 presented to a remote user on client computer 30 by Web Server 24. Web Page 500 includes a plurality of fields suitable for allowing the remote user to select from varying forms of ground transportation 502a-502f. The user completes the form and transmits the information to Web Server 24 by selecting Submit button 504. It shall be appreciated that other notification triggers, notification delivery methods, and the like may be provided for in alternative embodiments.

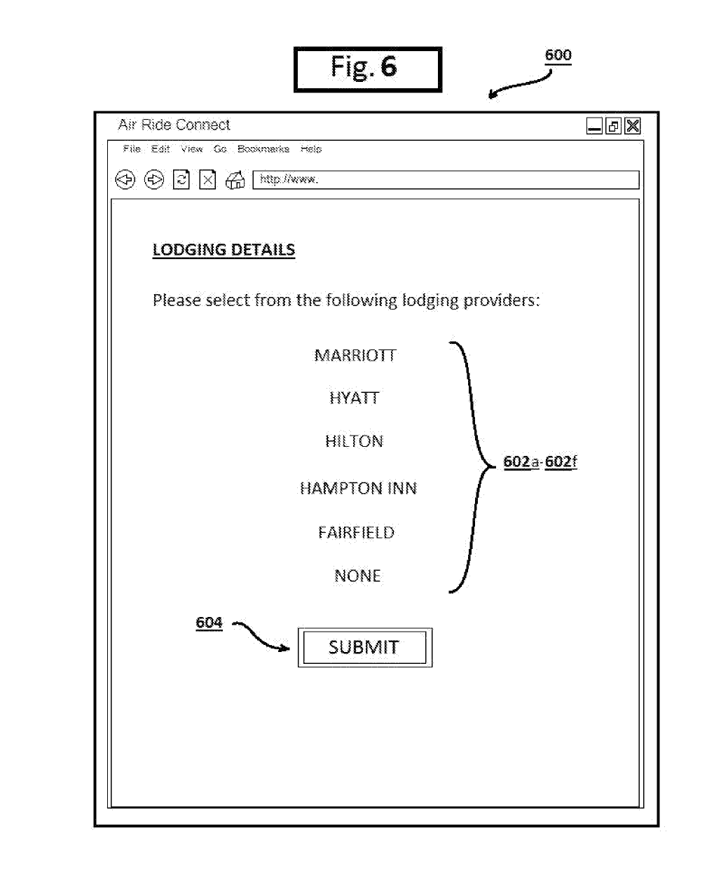

For purposes of illustration, and with continued reference to FIG. 1, FIG. 6 shows a sample web page 600 presented to a remote user on client computer 30 by Web Server 24. Web Page 600 includes a plurality of fields suitable for allowing the remote user to select from varying forms of lodging 602a-602f. The user completes the form and transmits the information to Web Server 24 by selecting Submit button 604. It shall be appreciated that other notification triggers, notification delivery methods, and the like may be provided for in alternative embodiments.

While the invention has been illustrated and described in detail in the drawings and foregoing description, the same is to be considered as illustrative and not restrictive in character, it being understood that only the preferred embodiment has been shown and described and that all equivalents, changes and modifications that come within the spirit of the inventions as described herein and/or by the following claims are desired to be protected. Hence, the proper scope of the present invention should be determined only by the broadest interpretation of the appended claims so as to encompass all such modifications as well as all relationships equivalent to those illustrated in the drawings and described in the specification.

What is claimed is:

1. A method facilitating the determination of which Fixed Based Operator (FBO) an aircraft will be disembarking from upon arrival at a destination airport through the combination of user contributed individual flight plan data comprising:
Obtaining electronic data from recent FAA filed flight plan pertaining to an aircraft's destination airport; and/or obtaining data inputted manually pertaining to a recent filed flight plan as to an aircraft's destination airport from individual users; Combining flight plan destination data with parsed data from a database server to populate a user selectable list of FBOs (or other public/private destinations) at the filed destination airport; presenting a list of FBOs (or other public/private destinations) for the user to select from; and storing user's selection results in a database.

2. A method facilitating the combination of user-contributed data and automatically populated data for the determination of the preferred method of ground transportation to be used upon arrival at an FBO (or other public/private destinations) by aircraft occupants comprising:
Receiving data selected through the method of claim 1 and, with or without user reentry, combining information from an electronic database containing differing ground transportation options; obtaining data inputted manually pertaining to ground transportation through user selection from choices presented; and storing user's selection results in a database.

3. A method facilitating the combination of user-contributed data and automatically populated data for the determination of the lodging to be used upon arrival at an FBO (or other public/private destinations) by aircraft occupants comprising:
Receiving data selected through the method of claim 1 and, with or without user reentry, combining information from an electronic database containing differing lodging options; obtaining data inputted manually pertaining to lodging through user selection from choices presented; and storing user's selection results in a database.

4. The method of claim 1, wherein said individual user data input is over the Internet.

5. The method of claim 2, wherein said user selectable data input is over the Internet.

6. The method of claim 3, wherein said user selectable data input is over the Internet.
